(19) United States
(12) Patent Application Publication
(10) Pub. No.: US 2016/0072858 A1
(43) Pub. Date: Mar. 10, 2016

(54) Methods and systems for remote interactive viewing

(71) Applicant: RIV Tech, Inc., Gilroy, CA (US)

(72) Inventors: Lee Heyne, Glendale, AZ (US); Joseph Lima, Gilroy, CA (US)

(21) Appl. No.: 14/483,121

(22) Filed: Sep. 10, 2014

(51) Int. Cl. H04L 29/06; G06F 17/30; G06F 3/0484; H04L 29/08

(52) U.S. Cl. CPC H04L 65/403; H04L 67/02; H04L 67/10; G06F 17/30896; G06F 3/04847

(57) ABSTRACT

Browser sharing technology, i.e., sharing a window of a web browser or a portion thereof. This browser sharing is lightweight, in that it does not require the installation of a thick or thin client. The browser downloads and executes code to facilitate browser sharing in the same way that it downloads and interprets HTML for webpage rendering. Embodiments of the present invention permit all of the viewers of the shared browser window to interact with the window as it is shared, and their interactions appear concurrently in all of views.

### FIELD

The invention relates generally to methods and systems for screen sharing, and more specifically to methods and systems that permit users to share the same view and concurrently interact with that view.

### BACKGROUND

There are several well-established technologies for sharing screens among multiple devices. These technologies can be grouped into two categories. The first category consist of systems that share rendering primitives, e.g., API calls or messages, across systems. Each system receives its own copy of the rendering primitives and executes them, which in theory will produce identical displays across devices. This approach is of particular interest when network communications among devices are bandwidth limited, unreliable, or otherwise low quality.

The second category consists of systems that share display bitmaps. These systems share the contents of a video memory among client devices, enabling pixel-by-pixel reproductions of a display. While this approach was disfavored for some time due to its bandwidth requirements, improvements in network communications as well as the strategic use of compression and other algorithms have rendered contemporary network connections suitable for these techniques. Moreover, solutions in this second category are technically simpler to implement; approaches in the first category can require access to proprietary knowledge, such as undocumented APIs, and can break unexpectedly if the rendering primitives or the associated protocols change.

However, most of these screen sharing solutions offer a “host/viewer” paradigm, where the host shares the host's screen with one or more viewers while maintaining control of the host's screen. The viewers watch passively as the host interacts with the host's display. Some of these solutions permit the host to handoff control to a particular viewer, making that viewer the new host while the old host becomes a viewer. This paradigm is not ideal for tasks that require multiple users to interact with the same view.

Accordingly, there is a need for methods and systems that offer screen sharing in a way that facilitates improved collaboration.

### SUMMARY OF THE INVENTION

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Various embodiments of the present invention provide browser sharing technology. In contrast to traditional screen sharing technology, which shares the entire desktop display, browser sharing only shares a window of a web browser or a portion thereof. This browser sharing is lightweight, in that it does not require the installation of a thick or thin client. The browser downloads and executes code to facilitate browser sharing in the same way that it downloads and interprets HTML for webpage rendering. Moreover, embodiments of the present invention permit all of the viewers of the shared browser window to interact with the window as it is shared, and their interactions appear concurrently in all of the views.

In a normal webpage, one element has focus at a time. If a user clicks, or gives focus, to an element, controls on the rest of the page lose focus, or “blur,” and cannot be interacted with. If on a webpage there are two text input boxes, the one with focus will receive input from the keyboard while the one that is “blurred” will not receive keyboard input. When making a webpage RIV compliant in accord with the present invention, each public control has two versions: a version as an interactive control (i.e., with normal focus/blur behavior) and a version as a view control. The interactive control is as described above and receives normal input. The view control is designed to replicate the interactive control but not actually take focus inside the document. In this example, a user that never used the interactive versions of the controls would effectively experience a screenshare. Furthermore, if two or more users are using the same control, both interactive and view versions of the control may be in use at once. If a first user has opened a calendar, the other users will see the calendar open as a view control. If a second user chooses a month on the calendar, using the view control as an interactive control, then the first user would see their interactive control update to the new month as the view control version synced with the second user's version. Any additional users in this scenario would see the view control for the selected calendar update as well.

With this understanding, i.e., that in conventional web browsers only one element on the webpage can have focus at a time, it is apparent how existing co-browsing solutions may operate. They offer two or more users the ability to share a screen, but when one user selects an item and brings focus to a control, then that control has to be interacted with or lose focus for all users to continue using the page because the interactive version of the controls in these prior art efforts may not be designed to allow more than one control to have focus. So existing co-browsing solutions, using standard controls, may not truly allow for more than one control to be operated at once. In contrast, embodiments of the present invention include interactive and view versions of each control and this allows for both normal and background updating of the controls to allow a true multi-user experience.

In one aspect the present invention relates to a system for browser sharing. The system includes a server, a first client, and a second client. The server has a first network interface and a first processor configured to transmit a model to at least two clients using the first network interface. The first client has a second network interface and a second processor configured to receive the model using the second network interface; render the model for display, the display including at least two interactive controls, with the first interactive control operated by an operator of the first client and the second interactive control operated by an operator of a second client; and transmit at least one operation of the first interactive control using the second network interface. The second client has a third network interface and a third processor configured to receive the model using the third network interface; render the model for display, the display including at least the first interactive control and the second interactive control; and transmit at least one operation of the second interactive control using the third network interface.

The displayed model on the first client and the displayed model on the second client are substantially identical and concurrently changing. In one embodiment, the model includes a state machine corresponding to a view of the webpage and the code necessary to present the state machine as a view; the model may be viewed as a webpage. Suitable interactive controls include dropdown menus, date pickers, radio buttons, text boxes, checkboxes, and buttons. In one embodiment, the first interactive control and the second interactive control are the same control. In another embodiment, the model for display may be rendered at each client using a web browser. In still another embodiment, the server transmits the model to at least one client after the at least one client selects a hyperlink directing to the server.

In one embodiment, the server is further configured to receive communications from at least two clients using the first network interface, the client communications comprising concurrent interactions with control rendered from the model at the client; and retransmit received communications to at least one client using the first network interface.

In another embodiment, one of the clients is further configured to receive communications from the other client using the client's network interface, the received communications comprising concurrent interactions with controls rendered from the model at the other client; and transmit communications to the other client using the client's network interface, the transmitted communications comprising concurrent interactions with controls rendered from the model at the first client.

In yet another embodiment, the displayed model includes a private section comprising controls, and interactions with the controls of the private section are not transmitted beyond the client hosting the interaction. In still another embodiment, the model includes private fields and public fields, the public fields of the displayed model on the first client and the public fields of the displayed model on the second client are substantially identical, and the private fields of the displayed model on the first client and the private fields of the displayed model on the second client are different. The model may be implemented as an HTML5 single-page application.

In another aspect, the present invention relates to a client for browser sharing. The client includes a network interface and a processor configured to receive a model using the network interface; render the model for display, the display including at least two interactive controls, with a first of the interactive controls operated by an operator of the client and a second of the interactive controls operated by an operator of a second client, wherein the display of the model is substantially identical to and concurrently changing with the display of the model on the second client.

In still another aspect, the present invention concerns a server for browser sharing, the server having a network interface and a processor configured to transmit a model to at least two clients using the network interface; receive communications from the at least two clients using the network interface, the client communications comprising concurrent interactions with controls rendered from the model at a client; and retransmit received communications to at least one client using the network interface, wherein the client communications comprise concurrent interactions with rendered models that are substantially identical and concurrently changing across the at least two clients.

In yet another aspect, the present invention concerns a method for browser sharing wherein at least two client computers each display substantially the same webpage, each displayed webpage permitting each operator of the at least two client computers to interact with the displayed webpage, and each concurrently displaying the interactions with the displayed webpage of all of the operators.

In one embodiment, the method further includes the exchange of communications among the at least two client computers describing the interactions with the displayed webpage of all of the operators. In another embodiment, a server facilitates the exchange of communications among the at least two client computers. In still another embodiment, the displayed webpage includes a private section that is not shared among the at least two client computers.

In one embodiment, the model includes a state machine corresponding to a view of the webpage and the code necessary to present the state machine as a view; the model may be viewed as a webpage. The model may be implemented as an HTML5 single-page application.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF DRAWINGS

Non-limiting and non-exhaustive embodiments are described with reference to the following figures in which:

FIG. 1 is a diagram of an exemplary system for browser sharing in accord with the present invention;

FIG. 2 depicts an exemplary RIV Server 104 in more detail;

FIG. 3 depicts an example of a client device 100^{N} in more detail;

FIGS. 4A-4C are a flowchart of methods for browser sharing in accord with the present invention; and

FIG. 5 shows the view from an exemplary client device participating in browser sharing.

In the drawings, like reference characters generally refer to corresponding parts throughout the different views. The drawings are not necessarily to scale, emphasis instead being placed on the principles and concepts of operation.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are the means used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions that could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

In brief overview, embodiments of the present invention provide browser sharing, i.e., the sharing of a browser window or a portion thereof across multiple clients, by downloading and executing code the same way that the browser downloads and interprets HTML for webpage rendering. Each operator of a client, i.e., a web browser executing on a computing device, may interact with the shared browser window as it is shared, and each operator's interactions appear concurrently in all of the views of the browser window.

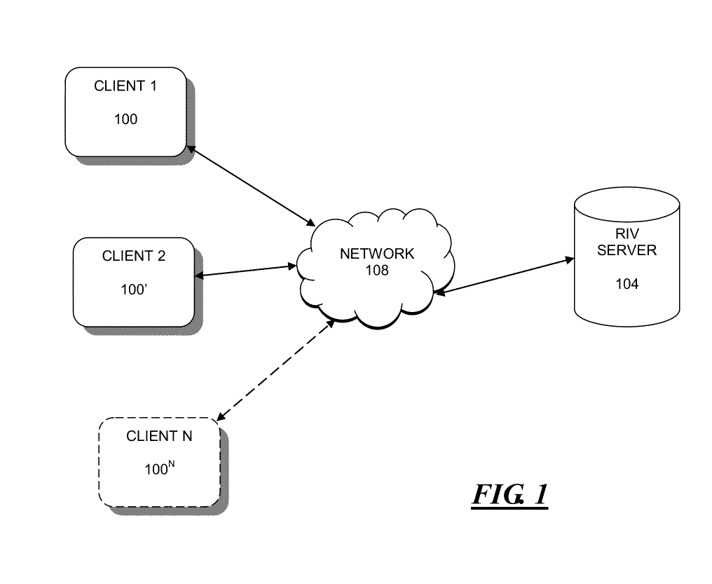

FIG. 1 depicts an exemplary embodiment of the present invention. A user operates a client device 100 such as a desktop computer or a laptop computer, although any device with a suitable interface and network connectivity such as a smartphone or tablet can be used. The client device 100 is in contact with a network 104 such as the Internet or a wide-area network utilizing, e.g., a wired or wireless interface. The form of interface may vary depending on the particular nature of the client device 100. Typical interfaces include gigabit Ethernet, Wi-Fi (802.11a/b/g/n), and 3G/4G wireless interfaces such as GSM/WCDMA/LTE that enable data transmissions between client device 100 and other devices in communication with the network 104.

Like client device 100, the remote interactive viewing (RIV) server 108 is also in communication with the network 104. The name “RIV server” is meant to identify the server by its role in various embodiments of the present invention. It is not intended to convey any particular limitation or restriction concerning the underlying technologies implementing the RIV server 104. In particular, various implementations of the RIV server 104 include physical server machines such as a locally-hosted server computer, a remotely-hosted server, locally or remotely hosted clusters of servers, a virtual machine hosted by an on-demand computing service such as ELASTIC COMPUTE CLOUD a.k.a. EC2 offered by AMAZON.COM, INC. of Seattle, Wash., etc.

A user of a first client device 100 wishes to engage in a collaborative task with at least one other user of a client device 100^{N}, preferably a task that would benefit from the sharing of a web browser pane among those users. The user of the first client device 100 contacts the RIV server 104 through the network 108 using techniques that are well understood, such as HTTP communications over TCP/IP. The RIV server 104 transmits, among other things, a model to the first client device 100 that may be displayed by the first client device 100 as a webpage.

The model is similar to a state machine and contains the current state necessary to present the view of the webpage. Each client device 100 as it renders the state machine transmits updates indicating the changes that it makes to the model, either to the other client devices 100 or the RIV server 104. That means that anytime a new user downloads the model and its current state, the new user's client device 100 can recreate the concurrent view from that state. An example of a piece of the model is {model:{destination: {val:‘Las Vegas’, expanded:true}, dateArrival: {val:‘2014-08-17’, expanded:true}, rooms:{val:2, expanded:false}}}, which indicates that certain user interface elements in the webpage have values of “Las Vegas,” Aug. 17, 2014, and “2.” For this particular model, “expanded” is similar to “focus” as usually given by clicking the mouse on a control. In this example, at least one user is interacting with the Destination as an interactive control and at least one user is interacting with the DateArrival as an interactive control. The user using the Destination as an interactive control is having their DateArrival view control updated in the background as it receives updates from one or more users using the DateArrival interactive control.

The webpage application contains the code necessary to present the model as a view. The application code can read the model parameters, e.g., model.currentState=Details, and know that it should hide Results and show Details. Depending on the particular embodiment, the application logic can be included as a piece of the model that is downloaded from the server. In that situation, every time a model is downloaded from the server, it contains the necessary application logic to display it. In one embodiment, the model is an HTML5 single-page application (SPA).

The browser at the first client device 100 renders the model and displays the resulting webpage which typically includes some sort of mechanism to facilitate the sharing of the displayed webpage with at least one other client device 100^{N}. Typical sharing mechanisms include a button that sends an instant message using one or more instant messaging techniques or an alphanumerical code that can be shared using a communications channel that is external to the browser, such as e-mail, a telephone call, a VOIP call, etc.

The operator of the second client device 100′ joins the sharing session by, e.g., independently contacting the RIV server 104 and entering a code received from the operator of the first client device 100, or clicking on a link received through an instant message or e-mail from the operator of the first client device 100, etc. The RIV server 104 provides the second client 100′ with its own copy of the model. If the clients 100^{N} are communicating in peer-to-peer mode, as discussed in greater detail below, then the model contains connection parameters to send information to the first client 100 and other clients 100^{N} participating in the sharing session. If the clients 100 are communicating through the server 104, then there is no need for this copy of the model to including information about the other clients 100.

In some embodiments, the RIV server 104 operates to facilitate sharing among the various client devices 100^{N}. As each operator of the client device 100^{N} interacts with the displayed webpage, and thereby interacts with the underlying model, the client device 100^{N} sends communications to the RIV server 104 summarizing those interactions and the RIV server 104 in turn retransmits those received communications to the other client devices 100^{N}. Each client device 100^{N} receives those communications from the RIV server 104, updates its model in accord with those communications, and in turn updates the webpage displayed to the operator of the client device.

The net effect of this arrangement is to ensure that each operator of a client device 100^{N} views substantially the same displayed webpage, i.e., effectively mirroring the contents of the pane in the web browser displaying the webpage, and that each operator's interactions with their copy of the webpage is viewed by all of the operators.

In some embodiments, the model displayed as a webpage includes private or other non-shared fields or other information. Examples of such items include payment dialogs, fields containing credit card information, etc. Those items may be designated as private at the time of creation of the model, or the model may include heuristics to identify such fields using keywords, URL addresses, etc. The model, when executing, does not share user interactions with those private fields with other users. In some embodiments, the private fields may be displayed with shading, a distinctive color, another form of highlighting, or hidden altogether to indicate to the user of the client device 100^{N} that the fields are private. This mode of operation facilitates browser sharing among a plurality of client devices 100^{N}, especially client devices 100^{N} lacking support for client-to-client communications. In other embodiments, the RIV server 104 operates to provide each client device 100^{N} with the model, as discussed above, but plays no part in subsequent communications among client devices 100^{N}. In this embodiment, the client devices 100^{N} are able to exchange information directly with each other using various technologies for peer-to-peer communications. For example, the client devices 100^{N} may elect one or more of the client devices 100^{N} to serve as a centralized intermediary for a cluster of client devices 100^{N}. In other embodiments, the client devices 100^{N} may track their nearest neighbor client devices 100^{N} and route messages for their peer devices.

In still other embodiments, a hybrid of these techniques are employed, i.e., with some of the client devices 100^{N} communicating with each other and other client devices 100^{N} using the RIV server 104 as an intermediary.

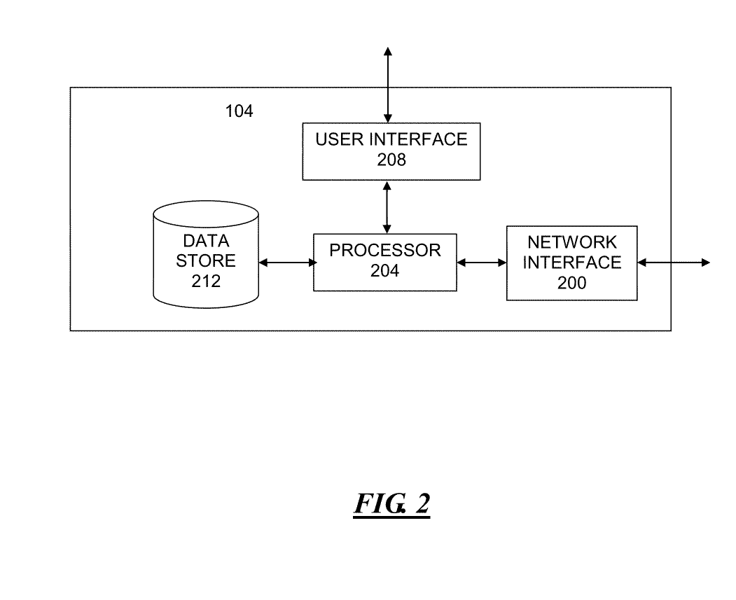

FIG. 2 describes the RIV server 104 in additional detail. As discussed above, the RIV server 104 can take various forms, physical and virtual, but most implementations will share certain common functionalities. The network interface 200 allows the RIV server 104 to receive communications from other devices and, in one embodiment, provides a bidirectional interface to the Internet. Suitable network interfaces 200 include gigabit Ethernet, Wi-Fi (802.11a/b/g/n), and 3G/4G wireless interfaces such as GSM/WCDMA/LTE that enable data transmissions between RIV server 104 and other devices. A processor 204 generates communications for transmission through the interface 200 and processes communications received through the interface 200 that originate outside the RIV server 104. A typical processor 204 is an x86, x86-64, or ARMv7 processor, and the like. The user interface 208 allows the RIV server 104 to receive commands from and provide feedback to an operator. Exemplary user interfaces include graphical displays, physical keyboards, virtual keyboards, etc. The data store 212 provides both transient and persistent storage for data received via the interface 200, data processed by the processor 204, and data received or sent via the user interface 208.

The interface 200 of the RIV server 104 is configured to handle communications among various client devices 100^{N}. The RIV server 104 receives communications from client devices 100^{N} such as operator interactions with models displayed as webpages and requests for models from web browsers. The RIV server 104 in turn communicates with the client devices 100^{N}, sending them such information as operator interactions occurring on client devices and requested models.

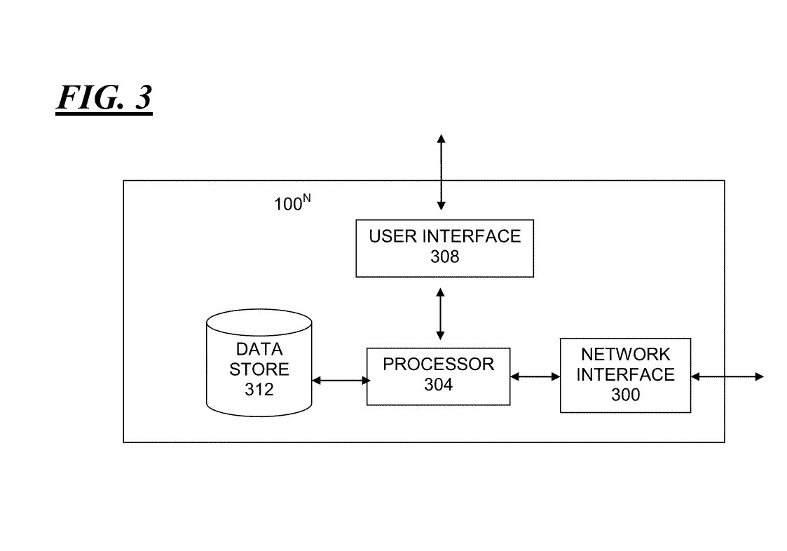

FIG. 3 describes an example of a client device 100^{N} in additional detail. A client device 100^{N} and the RIV server 104 are typically implemented using different technologies. For example, a RIV server 104 may be an array of virtual machines operating on a commercial cloud computing service, while a typical client device 100^{N} may be a laptop computer or a tablet. Despite the differences in implementing technologies, a typical end user device will possess or offer some of the same facilities present in the RIV server 104.

For example, the network interface 300 allows the client device 100^{N} to receive communications from other devices and, in one embodiment, provides a bidirectional interface to the Internet. Suitable network interfaces 300 include gigabit Ethernet, Wi-Fi (802.11a/b/g/n), and 3G/4G wireless interfaces such as GSM/WCDMA/LTE that enable data transmissions between client device 100^{N} and other devices. A processor 304 generates communications for transmission through the interface 300 and processes communications received through the interface 300 that originate outside the client device 100^{N}. A typical processor 304 is an x86, x86-64, or ARMv7 processor, and the like. The user interface 308 allows the client device 100^{N} to receive commands from and provide feedback to an operator. Exemplary user interfaces include graphical displays, physical keyboards, virtual keyboards, etc. The data store 312 provides both transient and persistent storage for data received via the interface 300, data processed by the processor 304, and data received or sent via the user interface 308.

The client device 100^{N} typically differs from the RIV server 104 in that it includes at least a web browser (not shown). The operator of the client device 100^{N} may operate the web browser using the user interface 308 to access one or more websites that may be, e.g., accessible over the network 108 using the network interface 300.

In certain embodiments, the user interface 308 of the client device 100^{N} permits the device operator to interact with a displayed webpage and see the interactions of other client device users with the same webpage. For example, one user may select a date picker on the webpage while another user types text into a text box, and each user will see the results of the actions of the other user concurrently with the results of their own interaction.

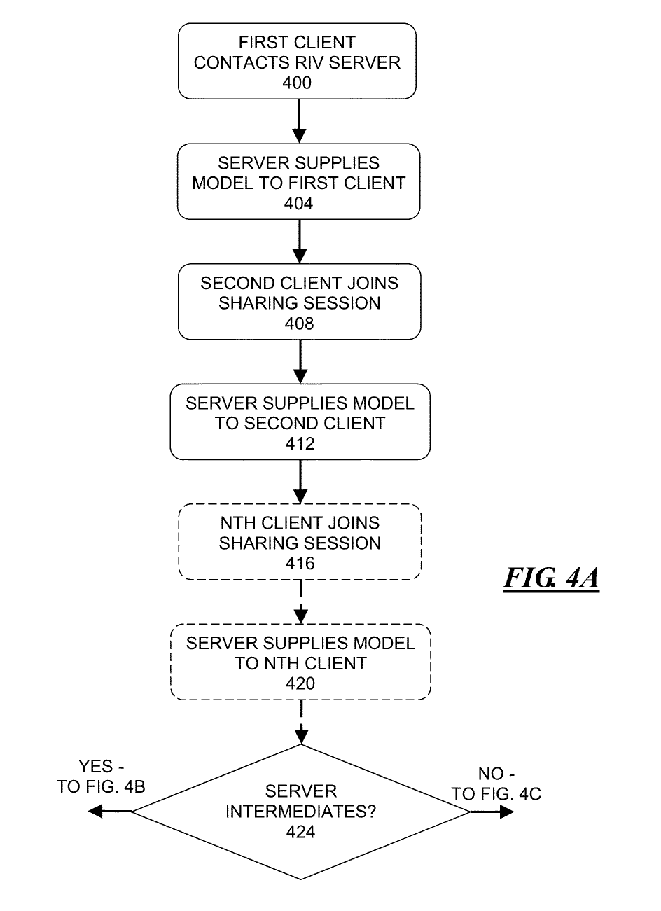

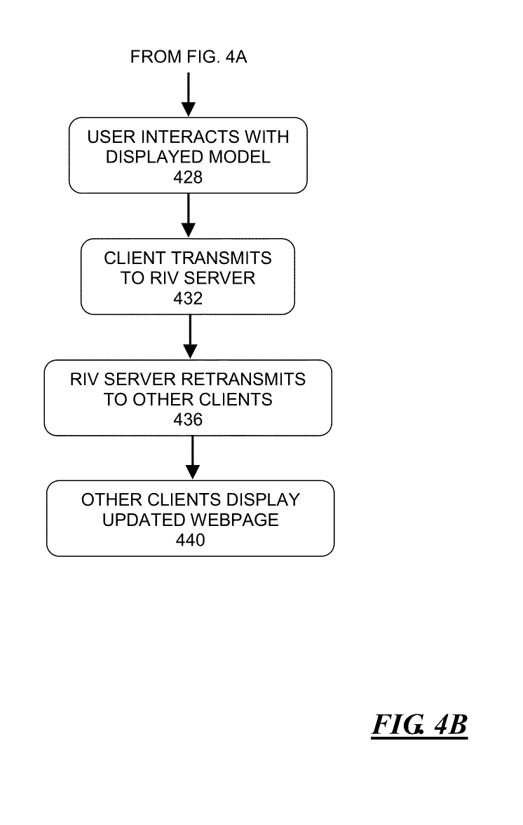

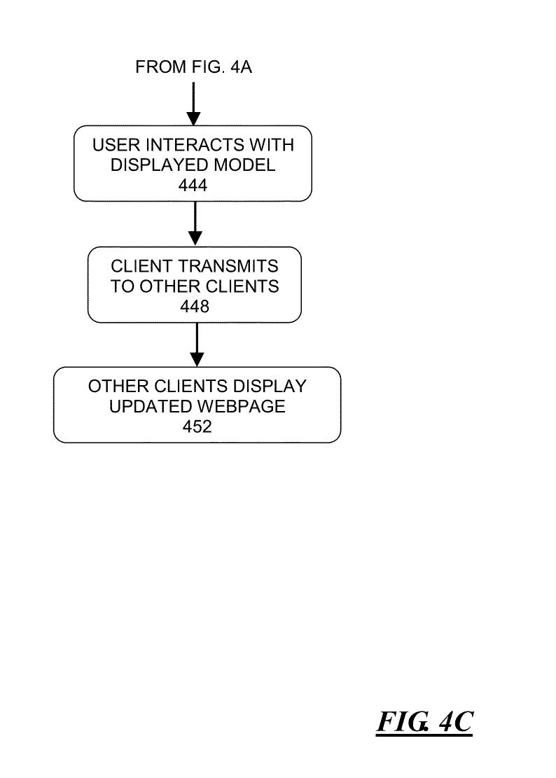

FIGS. 4A-4C are a flowchart of an exemplary method for browser sharing in accord with the present invention. The process begins when a user of a first client device wishes to engage in a collaborative task with at least one other user of another client device, preferably a task that would benefit from the sharing of a web browser pane among those users. The user of the first client device contacts the RIV server using techniques that are well understood (Step 400). The RIV server 104 transmits, among other things, a model to the first client device that may be displayed by the first client device as a webpage (Step 404).

The model includes code that implements the browser sharing functionality. The browser at the first client device renders the model and displays the resulting webpage which typically includes some sort of mechanism to facilitate the sharing of the displayed webpage with at least one other client device. Typical sharing mechanisms include a button that sends an instant message using one or more instant messaging techniques or an alphanumerical code that can be shared using a communications channel that is external to the browser, such as e-mail, a telephone call, a VOIP call, etc.

The operator of a second client device joins the sharing session by, e.g., independently contacting the RIV server and entering a code received from the operator of the first client device, or clicking on a link received through an instant message or e-mail from the operator of the first client device, etc. (Step 408). The RIV server provides the second client with its own copy of the model (Step 412), this copy including information about the first client and any other client participating in the sharing session when the clients are communicating in peer-to-peer mode, but not necessarily when the clients are communicating through the RIV server or another server. The process repeats for any other client devices joining the browser sharing session (Steps 416, 420).

In some embodiments, such as those illustrated in FIG. 4B, the RIV server operates to facilitate sharing among the various client devices (Step 424). As each operator of the client device interacts with the displayed webpage (Step 428), and thereby interacts with the underlying model, the client device sends communications to the RIV server summarizing those interactions (Step 432) and the RIV server in turn retransmits those received communications to the other client devices (Step 436). Each client device receives those communications from the RIV server, updates its model in accord with those communications, and in turn updates the webpage displayed to the operator of the client device (Step 440).

The net effect of this arrangement is to ensure that each operator of a client device views substantially the same displayed webpage, i.e., effectively mirroring the contents of the pane in the web browser displaying the webpage, and that each operator's interactions with their copy of the webpage is viewed by all of the operators.

In other embodiments, as illustrated in FIG. 4C, the RIV server operates to provide each client device with the model, as discussed above, but plays no part in subsequent communications among client devices (Step 424). As each operator of the client device interacts with the displayed webpage (Step 444) and thereby interacts with the underlying model, the client device sends communications to the other client devices summarizing those interactions (Step 448). Each client device receives those communications from the client device, updates its model in accord with those communications, and in turn updates the webpage displayed to the operator of the client device (Step 452). In still other embodiments, a hybrid of these techniques are employed, i.e., with some of the client devices communicating with each other and other client devices using the RIV server as an intermediary.

In some embodiments, the model displayed as a webpage includes private or other non-shared fields or other information. Examples of such items include payment dialogs, fields containing credit card information, etc. Those items may be designated as private at the time of creation of the model, or the model may include heuristics to identify such fields using keywords, URL addresses, etc. The model, when executing, does not share user interactions with those private fields with other users. In some embodiments, the private fields may be displayed with shading, a distinctive color, or another form of highlighting to indicate to the user of the client device 100^{N} that the fields are private.

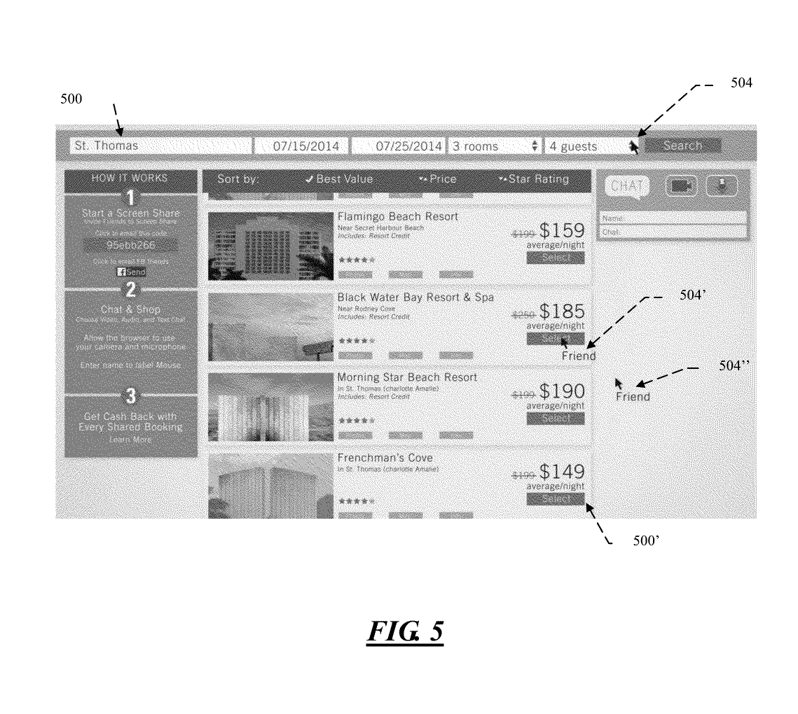

FIG. 5 shows an example of a webpage displayed at a client utilizing the browser sharing technology of the present invention. The user accesses the webpage by entering a URL in the navigation box of his web browser or clicking on a link that directs to the webpage. The user's web browser, e.g., CHROME offered by GOOGLE, INC. of Mountain View, Calif., establishes a connection with the web server hosting the webpage and downloads the content specifying the webpage, including the code and model implementing browser sharing, as discussed above.

The rendered webpage includes several control elements 500 such as buttons, text boxes, date pickers, etc., as would be typical to any webpage. Notably, however, there are multiple cursors 504 displayed in the browser window. The local user's cursor 504 is selecting the number of guests from a pop-up menu, while one user's cursor 504′ is selecting the “Black Water Report & Spa” and another user's cursor 504″ is hovering off to the side.

Each user in turn, is operating a client device executing a web browser that has downloaded the same model from the server and is displaying substantially the same view as that visible to the first user in FIG. 5. The only difference among the various displays is that each user controls his or her own cursor, and their operation of their cursor as it interacts with various webpage elements is displayed concurrently on the model display at each of the client devices involved in the browser sharing session.

It will be apparent to one of ordinary skill that the approach disclosed herein may be scaled to permit large-scale browser shares, perhaps allowing hundreds or thousands of users to share browser windows at the same time. Those particular embodiments may also include functionality that permits a sharing session to be subdivided into a plurality of sharing sessions, e.g., allowing a session with ten users to be split into two sessions of five users.

Additional embodiments of the present invention offer various additional inventive features. In one embodiment, a user interacting with a webpage can designate certain public controls as private or unchangeable by other users from time to time, permitting the user to effectively convert public controls into private controls at their option. Some embodiments feature encrypted communications among the client devices and/or encrypted communications between the client devices and the server. Still other embodiments include features designed to improve the robustness of browser sharing sessions, such that a client disconnected from a sharing session may rejoin the session. For example, model updates may include sequence numbers to permit discarding of duplicates, and a periodic “rebase” signal may be issued in case a client misses a model update and wishes to reestablish coherency with other models.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

What is claimed is:

1. A system for browser sharing, the system comprising:
a server comprising a first network interface and a first processor configured to transmit a model to at least two clients using the first network interface; and
a first client comprising a second network interface and a second processor configured to:
receive the model using the second network interface;
render the model for display, the display including at least two interactive controls, with the first interactive control operated by an operator of the first client and the second interactive control operated by an operator of a second client; and
transmit at least one operation of the first interactive control using the second network interface; and
the second client comprising a third network interface and a third processor configured to:
receive the model using the third network interface;
render the model for display, the display including at least the first interactive control and the second interactive control; and
transmit at least one operation of the second interactive control using the third network interface,
wherein the displayed model on the first client and the displayed model on the second client are substantially identical and concurrently changing.

2. The system of claim 1 wherein the server is further configured to:
receive communications from at least two clients using the first network interface, the client communications comprising concurrent interactions with controls rendered from the model at the client; and
retransmit received communications to at least one client using the first network interface.

3. The system of claim 1 wherein the first client is further configured to:
receive communications from the second client using the first network interface, the received communications comprising concurrent interactions with controls rendered from the model at the second client; and
transmit communications to the second client using the first network interface, the transmitted communications comprising concurrent interactions with controls rendered from the model at the first client.

4. The system of claim 1 wherein the first interactive control and the second interactive control are the same control.

5. The system of claim 1 wherein the displayed model includes a private section comprising controls, and interactions with the controls of the private section are not transmitted beyond the client hosting the interaction.

6. The system of claim 1 wherein each of the interactive controls is selected from the group consisting of a dropdown menu, a date picker, a radio button, a text box, a checkbox, and a button.

7. The system of claim 1 wherein the model for display is rendered at the first client using a web browser and model for display is rendered at the second client using a web browser.

8. The system of claim 1 wherein the model comprises private fields and public fields, the public fields of the displayed model on the first client and the public fields of the displayed model on the second client are substantially identical, and the private fields of the displayed model on the first client and the private fields of the displayed model on the second client are different.

9. The system of claim 1 wherein the server transmits the model to at least one client after the at least one client selects a hyperlink directing to the server.

10. The system of claim 1 wherein the model is viewed as a webpage.

11. The system of claim 1 wherein the model is an HTML5 single-page application.

12. The system of claim 1 wherein the model comprises a state machine corresponding to a view of the webpage and the code necessary to present the state machine as a view.

13. A client for browser sharing, the client comprising:
a network interface; and
a processor configured to:
receive a model using the network interface;
render the model for display, the display including at least two interactive controls, with a first of the interactive controls operated by an operator of the client and a second of the interactive controls operated by an operator of a second client,
wherein the display of the model is substantially identical to and concurrently changing with the display of the model on the second client.

14. A server for browser sharing, the server comprising:
a network interface; and
a processor configured to:
transmit a model to at least two clients using the network interface;
receive communications from the at least two clients using the network interface, the client communications comprising concurrent interactions with controls rendered from the model at a client; and
retransmit received communications to at least one client using the network interface,
wherein the client communications comprise concurrent interactions with rendered models that are substantially identical and concurrently changing across the at least two clients.

15. A method for browser sharing wherein at least two client computers each display substantially the same webpage, each displayed webpage permitting each operator of the at least two client computers to interact with the displayed webpage, and each concurrently displaying the interactions with the displayed webpage of all of the operators.

16. The method of claim 15, further comprising the exchange of communications among the at least two client computers describing the interactions with the displayed webpage of all of the operators.

17. The method of claim 16 wherein a server facilitates the exchange of communications among the at least two client computers.

18. The method of claim 15 wherein the displayed webpage includes a private section that is not shared among the at least two client computers.

18. The method of claim 16 wherein the model is an HTML5 single-page application.

19. The method of claim 16 wherein the model comprises a state machine corresponding to a view of a webpage and the code necessary to present the state machine as a view.
